(19) United States
(12) Patent Application Publication
(10) Pub. No.: US 2026/0081044 A1
(43) Pub. Date: Mar. 19, 2026

(54) CONTROL ROD APPARATUS FOR SMALL MODULAR REACTOR, AND SMALL MODULAR REACTOR COMPRISING SAME

(71) Applicant: Dunedin Energy Systems Limited, Oro-Medonte (CA)

(72) Inventor: Robert Harvey, Oro-Medonte (CA)

(21) Appl. No.: 19/327,140

(22) Filed: Sep. 12, 2025

Related U.S. Application Data
(60) Provisional application No. 63/695,070, filed on Sep. 16, 2024.

(51) Int. Cl. G21C 7/14; G21C 7/18; G21C 7/24; G21C 9/02

(52) U.S. Cl. CPC G21C 7/14; G21C 7/18; G21C 7/24; G21C 9/02

(57) ABSTRACT

A local control unit for a small modular reactor includes: a local control rod set comprising a pair of movable local control rods; and a local control unit drive mechanism coupled to the pair of local control rods. The local control unit drive mechanism is configured to move each of the local control rods in opposite directions simultaneously.

### CROSS-REFERENCE TO RELATED APPLICATION

This application claims the benefit of U.S. Provisional Application No. 63/695,070 filed Sep. 16, 2024, the content of which is incorporated herein by reference in its entirety.

### FIELD

The subject disclosure relates generally to nuclear power and in particular, to a reactor control apparatus for a small modular reactor, and a small modular reactor comprising the same. The reactor control apparatus is comprised of a neutron absorbing control rod, a drive mechanism with which to move the control rod and various supporting and guiding structures.

### BACKGROUND

In the field of electrical power generation, nuclear power plays a significant role. In Canada, nuclear power accounts for 15% of all electrical power generated, while in the United States, nuclear power accounts for 19% of all electrical power generated. The vast majority of this nuclear power is generated using thermal neutron spectrum reactors, which use water as a neutron moderator and as a primary heat transport medium.

An emerging category of nuclear reactor is the small modular reactor (SMR), which is generally defined as having a power output of 300 megawatts electric (MWe) or less. Within SMRs, there exists a category of smaller reactors known as micro-reactors (MRs), which are defined as having a power output of about 15 MWe or less. Some SMRs and MRs use solid materials, such as graphite, as a neutron moderator. These reactors are generally referred to as “solid-state” nuclear reactors, due to their solid reactor core. Solid-state nuclear reactors are generally compact and have a relatively simple construction.

Small modular reactors with heat pipes have been described. For example, the non-patent publication entitled “The Nuclear Battery: a Solid-State, Passively cooled Reactor for the Generation of Electricity and/or High-Grade Steam Heat” (AECL-9570) authored by K. S. Kozier and H. E. Rosinger and published by Atomic Energy of Canada Limited (1988), describes development of a small, solid-state, passively cooled reactor power supply known as the Nuclear Battery. Key technical features of the Nuclear Battery reactor core include a heat-pipe primary heat transport system, graphite neutron moderator, low-enriched uranium TRISO coated-particle fuel and the use of burnable poisons for long-term reactivity control. An external secondary heat transport system extracts heat energy from the upper portions of the heat pipes, which may be converted into electricity in a Rankine cycle turbogenerator or used to produce high-pressure steam. The design is capable of producing about 2400 kWt (about 600 kWe) for 15 full-power years.

Improvements are generally desired. It is an object at least to provide a novel reactor control apparatus for a small modular reactor, and a small modular reactor comprising the same.

### SUMMARY

Accordingly, in one aspect there is provided a local control unit for a small modular reactor, the local control unit comprising: a local control rod set comprising a pair of movable local control rods; and a local control unit drive mechanism coupled to the pair of local control rods, the local control unit drive mechanism being configured to move each of the local control rods in opposite directions simultaneously.

The local control unit drive mechanism may be coupled to the pair of local control rods by a plurality of wire ropes. The local control unit drive mechanism may comprise: an electric drive motor; a rotatable shaft coupled to the electric drive motor and supporting a plurality of drums around which the wire ropes are wound, the shaft being configured to be rotated upon activation of the electric drive motor. The pair of movable local control rods may comprise an upper local control rod and a lower local control rod, and wherein the plurality of drums may comprise: a first drum having a first helical, circumferential groove defined therein and configured to accommodate a length of a first wire rope coupled to the lower local control rod, and a second drum having a second helical, circumferential groove defined therein and configured to accommodate a length of a second wire rope coupled to the upper local control rod, wherein the second helical, circumferential groove is helically opposite to the first helical, circumferential groove relative to an axis of rotation of the shaft. The plurality of drums may further comprise: a third drum having a third helical, circumferential groove defined therein and configured to accommodate a length of a third wire rope coupled to the upper local control rod, wherein the third helical, circumferential groove is helically opposite to the first helical, circumferential groove relative to the axis of rotation of the shaft. The lower local control rod may comprise a first lower local control rod segment and a second lower local control rod segment, the first and second lower local control rod segments having a nested configuration. The first lower local control rod segment and the second lower local control rod segment may be configured to move telescopically relative to each other.

In another aspect, there is provided a reactor control unit subsystem for a small modular reactor comprising a reactor core, the reactor control unit subsystem comprising: a plurality of shutoff units; a plurality of guaranteed shutdown units; and a plurality of local control units, each local control unit comprising: a local control rod set comprising a pair of movable local control rods; and a local control unit drive mechanism coupled to the pair of local control rods, the local control unit drive mechanism being configured to move each of the local control rods in opposite directions simultaneously into or out of the core.

Each shutoff unit may comprise: a shutoff rod, and a shutoff rod drive mechanism coupled to the shutoff rod and configured to move the shutoff rod into the core, and each guaranteed shutdown unit may comprise: a guaranteed shutdown rod, and a guaranteed shutdown unit drive mechanism coupled to the guaranteed shutdown rod and configured to move the guaranteed shutdown rod into the core. Each of the local control rods, the shutoff rod, and the guaranteed shutdown rod may comprise: a pair of concentrically arranged tubular sleeves of different diameter defining an annular volume therebetween, the tubular sleeves being fabricated of a first material; a pair of caps disposed at ends of the tubular sleeves sealing the annular volume; and a plurality of annular bodies of a second material, the second material having a higher neutron capture cross section than the first material. The second material may be boron carbide. The first material may be stainless steel.

### BRIEF DESCRIPTION OF THE DRAWINGS

Embodiments will now be described more fully with reference to the accompanying drawings in which:

FIG. 1 is a schematic view of a nuclear power generating system;

FIG. 2 is a perspective, sectional view of a small modular reactor forming part of the nuclear power generating system of FIG. 1;

FIG. 3 is a sectional side view of a portion of the nuclear power generating system of FIG. 1;

FIG. 4 is a schematic top view of the core of the reactor of FIG. 2, showing the relative positions of local control units, shutoff units, and guaranteed shutdown units;

FIG. 5 is a fragmentary, sectional view of a portion of the reactor of FIG. 2, showing the local control units, the shutoff units, and the guaranteed shutdown units;

FIGS. 6A and 6B are sectional perspective views of a local control rod set, comprising a pair of opposingly-movable upper and lower local control rods, and forming part of the reactor of FIG. 2, in fully withdrawn and fully inserted configurations respectively;

FIGS. 6C and 6D are sectional perspective views of the local control rod set of FIGS. 6A and 6B respectively, showing portions of the surrounding reactor;

FIG. 7 is an enlarged fragmentary view of a portion of the lower local control rod of FIGS. 6A and 6B;

FIG. 8 is a perspective view of a gimbal ring forming part of the upper local control rod of FIGS. 6A and 6B;

FIG. 9 is a sectional perspective view of portions of a guide tube and a thimble forming part of the reactor of FIG. 2;

FIG. 10 is a sectional perspective view of local control rod drive mechanism, a bellows, a shield plug and a portion of the thimble forming part of the reactor of FIG. 2;

FIGS. 11A, 11B and 11C are perspective views of outer portions and a central portion forming part of the shield plug of FIG. 10;

FIG. 12 is an enlarged fragmentary view of the local control rod drive mechanism and bellows of FIG. 10;

FIG. 13 is a perspective view of drums and a shaft forming part of the local control rod drive mechanism of FIG. 10;

FIG. 14 is an enlarged fragmentary view of a rotation limit assembly forming part of the local control rod drive mechanism of FIG. 10;

FIGS. 15A and 15B are perspective views of the rotation limit assembly of FIG. 14, at each of the rotation limits;

FIG. 16 is a perspective view of a shutoff rod forming part of the reactor of FIG. 5;

FIG. 17 is a sectional perspective view of a portion of the shutoff rod of FIG. 16; and

FIG. 18 is a sectional perspective view of the shutoff rod, a shield plug and portions of a bellows and a conduit forming part of the reactor of FIG. 5.

### DETAILED DESCRIPTION OF THE EMBODIMENTS

The foregoing summary, as well as the following detailed description of certain examples will be better understood when read in conjunction with the appended drawings. As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Moreover, unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including by not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of description to describe the relationship of an element or feature to another element or feature as illustrated in the figures. The spatially relative terms can however, encompass different orientations in use or operation in addition to the orientation depicted in the figures.

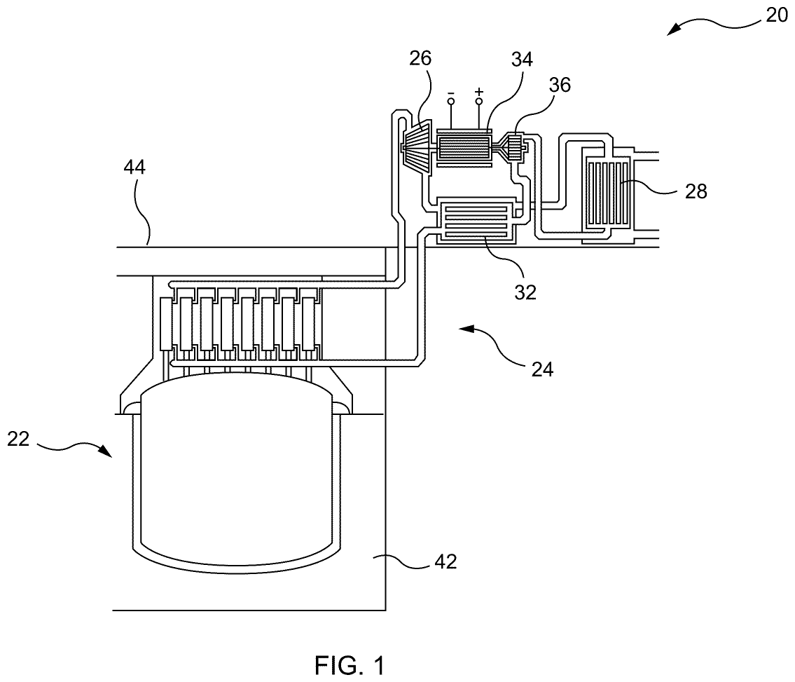

Turning now to FIG. 1, a nuclear power generating system is shown and is generally indicated by reference numeral 20. System 20 comprises a nuclear reactor in the form of a small modular reactor (SMR). The system 20 is configured to sustain nuclear fission for generating electricity, more broadly referred to as generating nuclear power. In particular, the system 20 comprises a small modular reactor 22 and a closed, secondary cooling circuit 24 that is in thermal communication with a heat exchange apparatus outside of, and above, the reactor 22. The secondary cooling circuit 24 has a heat exchange fluid flowing directionally therethrough. In the example shown, the heat exchange fluid is toluene, however it will be understood that other suitable organic or inorganic heat exchange fluids may alternatively be used. The secondary cooling circuit 24 is in fluidic communication with a turbine 26 positioned downstream of the reactor 22, a condenser 28 positioned downstream of the turbine 26, and a regenerator 32 positioned downstream of the condenser 28. The turbine 26 is coupled to an alternator 34 and a pump 36. As will be understood, the system 20 is configured to generate electricity using heat generated by the reactor 22 through i) vaporization of the heat exchange fluid to generate vaporized heat exchange fluid, which ii) rotates the turbine 26 and hence the alternator 34, and iii) is subsequently condensed by the condenser 28 and is returned to the heat exchange apparatus above the reactor 22, thereby completing an organic Rankine cycle.

The underside of the reactor 22 is surrounded by a shield 42 that is configured to contain thermal leakage, as well as any radioactive leakage, from the reactor 22. The shield 42 may be fabricated of concrete, for example. In the example shown, the reactor 22 and the shield 42 are shown as being positioned below grade 44, however it will be understood that the reactor 22 and the shield 42 may alternatively be positioned differently relative to grade.

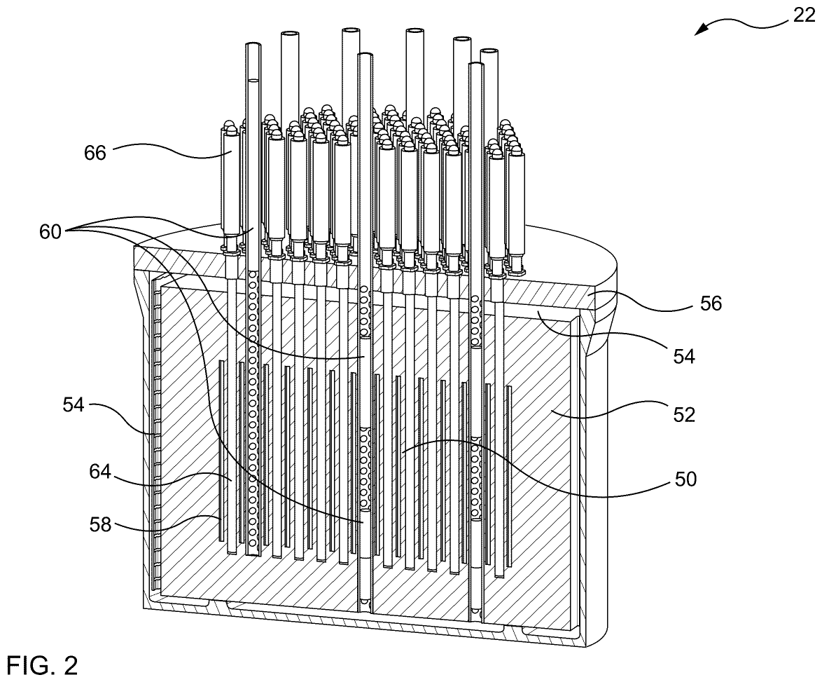

The reactor 22 may be better seen in FIG. 2. In the example shown, the reactor 22 is a small modular reactor (SMR) and is of smaller size than conventional, light water-or heavy water-cooled nuclear reactors. The reactor 22 comprises a reactor core 50 fabricated of solid graphite, and as a result the reactor 22 may be termed a “solid-state” nuclear reactor. The core 50 is surrounded by a neutron reflector layer 52, which is configured to reduce transmission or “leakage” of neutrons from the core 50. In the example shown, the neutron reflector layer 52 is graphite. A thermal insulation layer 54 surrounds the side and top of the neutron reflector layer 52. The core 50, neutron reflector layer 52 and thermal insulation layer 54 are, in turn, housed within a generally cylindrical reactor vessel 56. In the example shown, the reactor vessel 56 is fabricated of stainless steel, such as austenitic stainless steel, and has an inner diameter of about 3.9 m and an inner height of about 2.8 m, however it will be understood that the reactor vessel 56 may alternatively be differently sized. The reactor vessel 56 is generally fluidically sealed from its surroundings, and contains an inert atmosphere containing one or more inert gases, such as helium, argon and the like. As will be understood, the inert atmosphere contained in the reactor vessel 56 prevents oxidation of the contents of the core 50 at the elevated temperature (namely, 600° C. or higher) experienced during operation.

The core 50 has a spaced arrangement of bores formed therein for accommodating fuel rods 58, control rods 60 of reactor control units 62, and heat pipes 64. The fuel rods 58 and the heat pipes 64 are static, while the control rods 60 of the reactor control units 62 are configured to be moved into and out of the core 50 for indirectly controlling the heat output of the reactor 22 during operation.

Each fuel rod 58 comprises a plurality of generally cylindrical fuel compacts (not shown) that are stacked in an end-to-end manner within a respective bore formed in the core 50. The fuel compacts each comprise a plurality of spherical fuel kernels (not shown) of low-enriched uranium dioxide (UO₂) having a diameter of about 0.5 mm. Each fuel kernel is sealed in successive layers of carbonaceous materials (not shown), namely a layer of low-density buffer graphite, a first layer of high-density pyrolytic carbon, a layer of silicon carbide (SiC), and a second layer of high-density pyrolytic carbon, to form a coated kernel (not shown) having a diameter of about 0.9 mm. The coated kernels are in turn mixed with a graphite matrix binder (not shown) and formed into the solid, generally cylindrical fuel compact.

Each heat pipe 64 is a sealed metallic tube that contains a quantity or “charge” of alkali metal that serves as a working fluid (not shown) during operation. The pressure of the working fluid within the heat pipe 64 is sub-atmospheric. In this embodiment, the working fluid is sodium, however in other embodiments the working fluid may alternatively be potassium. The interior of each heat pipe 64 comprises a cylindrical, meshed liner (not shown) that extends the interior length of the heat pipe 64. As will be understood, the perforated configuration of the meshed liner provides a surface, and hence a flow path, along which liquid working fluid may readily flow by wicking. As the meshed liner is porous, the vaporized working fluid and the wicked liquid working fluid are able to contact each other. During operation of the reactor 22, heat energy generated by fission occurring in the fuel rods 58 travels through the core 50 to the heat pipes 64. The heat energy vaporizes the working fluid in the interior of the heat pipe 64. The vaporized working fluid flows upward through the heat pipe 64.

The heat pipe 64 has a vaporizer 66 disposed thereon for facilitating heat transfer from the heat pipe 64 to the heat exchange fluid flowing through the secondary cooling circuit 24. The vaporizer 66 comprises a hollow body (not shown) that defines a helical, internal passage (not shown). The internal passage is in fluidic communication with the secondary cooling circuit 24 via an input port (not shown) and an output port (not shown). As will be understood, the internal passage is configured to provide a conduit through which the incoming heat exchange fluid can flow to absorb heat from the working fluid, become vaporized upon absorption of a sufficient amount of heat, and subsequently reenter the secondary cooling circuit 24 as outgoing heated vapor, thereby enabling heat exchange between the reactor 22 and the secondary cooling circuit 24. The heat pipe 64 may be, for example, the heat pipe described in U.S. application Ser. No. 18/974,111 filed Dec. 9, 2024 and titled “HEAT PIPE FOR SMALL MODULAR REACTOR, AND NUCLEAR POWER GENERATING SYSTEM COMPRISING SAME”, the content of which is incorporated herein by reference in its entirety.

The reactor 22 utilizes three (3) different types of reactor control units 62 to control the rate of heat energy production in the core 50. Generally, the three (3) different types are 1) local control units, which provide local control of thermal power during normal operation, 2) shutoff units, which rapidly stop the nuclear fission chain reaction in the event that the local control units are unable to adequately manage the thermal power output of the reactor 22 or in the event of other emergent situations; and 3) guaranteed shutdown units, which place and maintain the reactor 22 in a state where a fission chain reaction cannot be started or sustained.

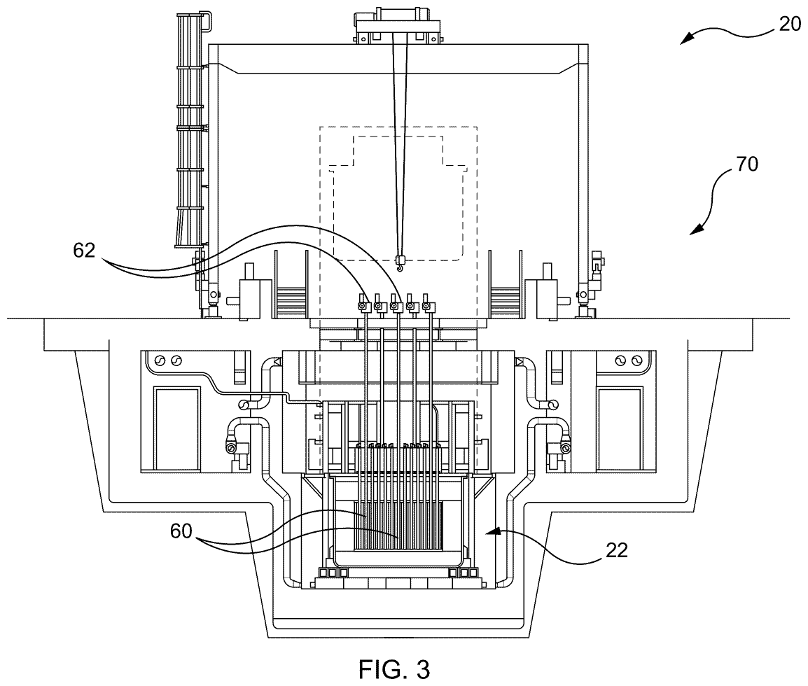

As shown schematically in FIG. 3, each reactor control unit 62 comprises a moveable control rod (or two moveable control rods in the case of the local control rods) 60, a control rod drive mechanism 68 positioned above the reactor 22, and wire roping coupling the control rod 60 to the control rod drive mechanism 68. Each reactor control unit 62 is individually configured to move its control rod 60 into and out of the core 50 through operation of its control rod drive mechanism 68, in response to signals from various reactor control systems (not shown) running process control application programs for generally controlling operation of the system 20. As will be understood, each control rod 60 is configured to absorb free neutrons to control the rate of nuclear fission occurring in the core 50, and thereby control the rate of heat energy production in the core 50 and hence the heat output of the reactor 22. The amount of absorption of free neutrons by each control rod 60 is generally proportional to the extent to which the control rod 60 is inserted into the core 50.

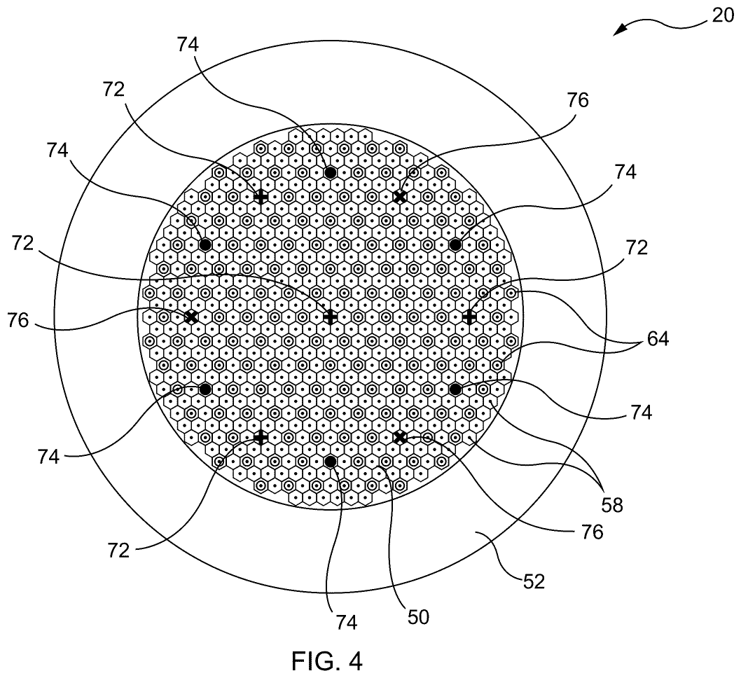

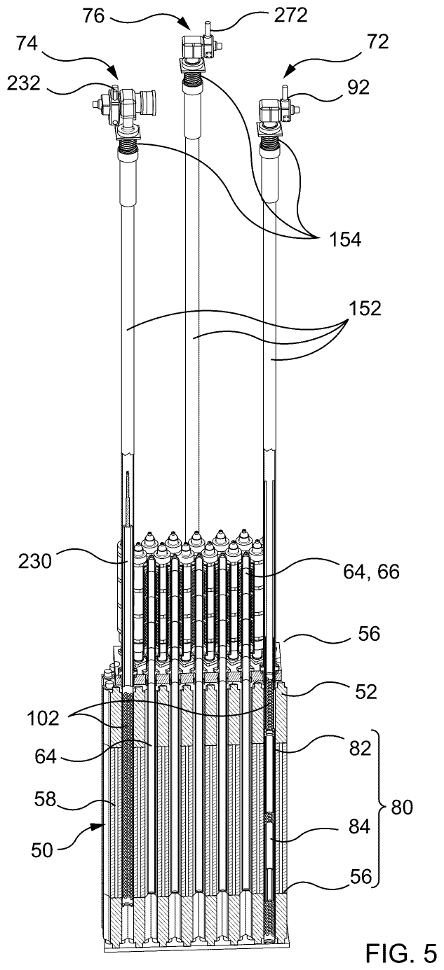

In the example, shown, the reactor control units 62, which make up reactor control unit subsystem 70 of the reactor 22, include local control units 72, shutoff units 74 and guaranteed shutdown units 76, which are spatially distributed across the diameter of the core 50 as shown in FIG. 4. As will be understood, each control rod drive mechanism 68 is located at the top of its corresponding reactor control unit 62, as shown in FIG. 5.

Each local control unit 72 comprises a local control rod set 80 comprising a vertical pair of opposingly-movable local control rods (namely, upper local control rod 82 and a lower local control rod 84, described below) that are configured to be moved into and out of the core 50 to manage the neutrons available for fission. This in turn manages the heat output of the reactor 22 to a desired, non-zero value during operation. Each local control rod set 80 is coupled to a respective local control rod drive mechanism 92 positioned above the reactor 22. The local control rod drive mechanisms 92 are in communication with the various reactor control systems (not shown) running process control application programs for generally controlling operation of the system 20.

The local control rod set 80 may be better seen in FIGS. 5 to 8. Each local control rod set 80 comprises two (2) moveable portions, namely the upper local control rod 82 and the lower local control rod 84, that are each independently connected to the local control rod drive mechanism 92 by wire ropes. In the example shown, the upper local control rod 82 is independently connected to the local control rod drive mechanism 92 by a pair of first wire ropes 96, and the lower local control rod 84 is independently connected to the local control rod drive mechanism 92 by a single, second wire rope 98.

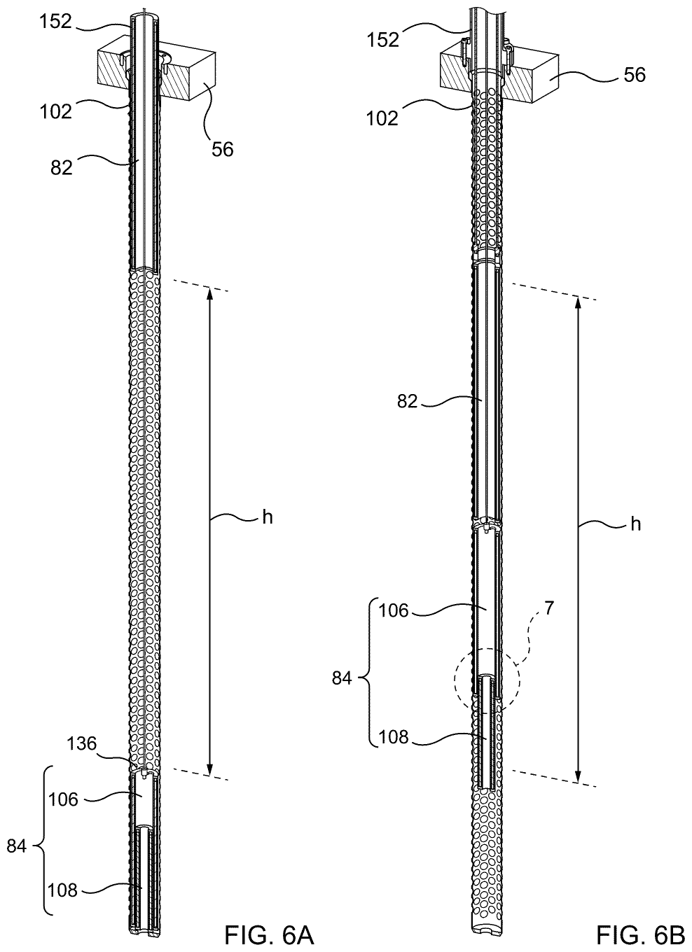

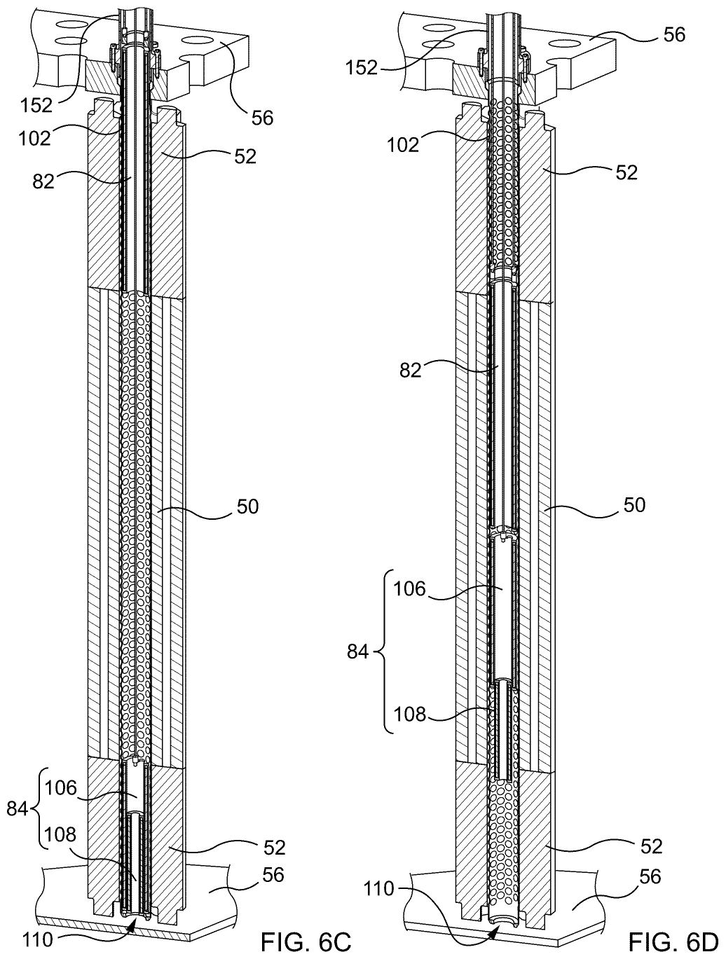

The upper local control rod 82 and lower local control rod 84 are configured to move vertically toward each other, or vertically away from each other, through the interior of a common guide tube 102 in response to action by the local control rod drive mechanism 92. In particular, the upper local control rod 82 and the lower local control rod 84 are configured to move within a movement range defined by travel limits governed by the local control rod drive mechanism 92, as described below. The local control rod drive mechanism 92 is configured such that, in each pair of upper local control rod 82 and lower local control rod 84, movements of the portions 82 and 84 are equal in displacement and velocity, but opposite in direction. The travel limits correspond to fully withdrawn and fully inserted configurations of the upper and lower local control rods 82 and 84, shown in FIGS. 6A and 6B respectively. The upper and lower local control rods 82 and 84 are configured such that, when in the fully withdrawn configuration, the upper and lower local control rods 82 and 84 are separated by a distance that is greater than a height of the fueled portion of the core 50, h, and when in the fully inserted configuration, the upper and lower local control rods 82 and 84 abut, or very nearly abut, to extend a combined length that is generally centered within, and exceeds, the height, h.

The lower local control rod 84 comprises two (2) telescoping, longitudinal segments, namely a first lower local control rod segment 106 and a second lower local control rod segment 108, that are configured to transition between a nested configuration and an extended configuration in response to action by the local control rod drive mechanism 92. Although not shown in FIG. 2 or 3, when in the nested configuration, the first lower local control rod segment 106 and the second lower local control rod segment 108 are accommodated in a bore 110 defined in the neutron reflector layer 52 (see FIGS. 5, 6C and 6D).

The first lower local control rod segment 106 has a generally tubular construction, and comprises a pair of tubular sleeves 112 and 114 of different diameter that are sealed at each end by a respective end cap to define an annular volume therebetween. The annular volume defined between the tubular sleeves 112 and 114 accommodates a quantity of material having a high neutron capture cross section. In the example shown, the tubular sleeves 112 and 114 are fabricated of stainless steel, and the material having high neutron capture cross section accommodated therebetween is in the form of a stack of annular bodies 116 of pressed and sintered boron carbide. One or more other suitable materials having high neutron capture cross section could alternatively or additionally be used, depending on neutron absorption requirements and rod life expectancy requirements.

The second lower local control rod segment 108 also has a generally tubular construction, and is sized to be accommodated within the first lower local control rod segment 106. The second lower local control rod segment 108 comprises a pair of tubular sleeves 122 and 124 of different diameter that are sealed at each end by a respective end cap to define an annular volume therebetween. The annular volume defined between the tubular sleeves 122 and 124 accommodates a quantity of material having a high neutron capture cross section. In the example shown, the tubular sleeves 122 and 124 are fabricated of stainless steel, and the material having high neutron capture cross section accommodated therebetween is in the form of a stack of annular bodies 126 of pressed and sintered boron carbide. Again, one or more other suitable materials having high neutron capture cross section could alternatively or additionally be used, depending on neutron absorption requirements and rod life expectancy requirements.

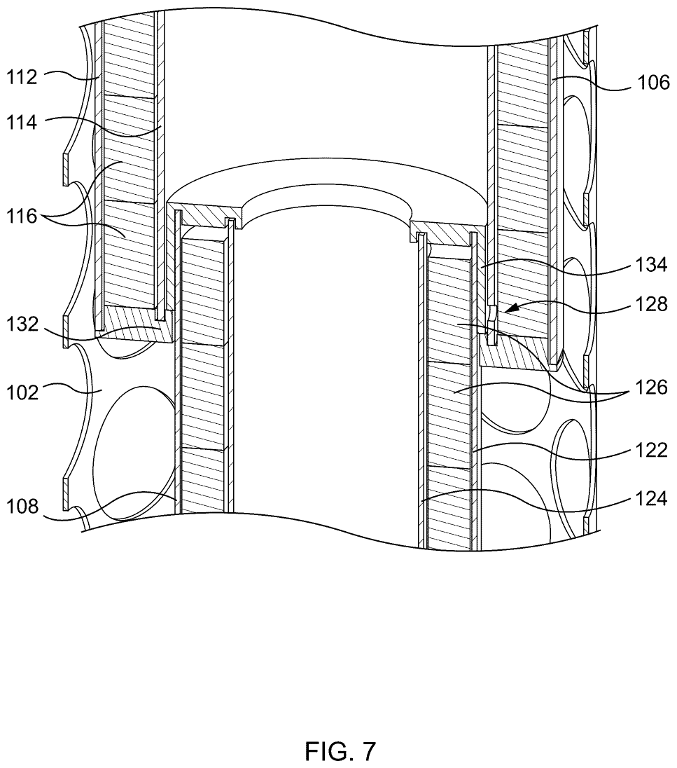

Each of the tubular sleeves 112, 114, 122 and 124 has one or more vent apertures 128 defined therein for i) prior to operation of the reactor 22, allowing atmospheric air present in the interior volume of the first lower local control rod segment 106 and the second lower local control rod segment 108 to be purged when the reactor vessel 56 is filled with helium; and ii) during operation of the reactor 22, allowing gas pressure generated in the interior volume of the first lower local control rod segment 106 and the second lower local control rod segment 108 to escape. As will be understood, during operation, absorption of neutrons by the material having high neutron capture cross section (namely, the annular bodies 116 of boron carbide) can result in transformation of boron atoms into lithium atoms and additional gaseous helium atoms. By providing vent apertures 128, the additional gaseous helium is advantageously able to exit the first lower local control rod segment 106 and the second lower local control rod segment 108, and thereby preventing an unsafe build-up of pressure inside the rod assemblies. Although only a single vent aperture 128 is shown in the particular section shown in FIG. 7, it will be understood that each of the tubular sleeves 112, 114, 122 and 124 has multiple vent apertures 128 along its length as defined therein.

The first lower local control rod segment 106 and second lower local control rod segment 108 are coupled to each other by a pair of circumferential cuffs, namely a first circumferential cuff 132 disposed at a lower end of the first lower local control rod segment 106, and a second circumferential cuff 134 disposed at an upper end of the second lower local control rod segment 108.

The lower local control rod 84 is connected to the second wire rope 98 via a securing plate 136, which is coupled to an upper end of the first lower local control rod segment 106.

The upper local control rod 82 has a similar construction to each of the first and second lower local control rod segments 106 and 108. In particular, the upper local control rod 82 has a generally tubular construction, and comprises a pair of tubular sleeves (not shown) of different diameter that are sealed at each end by a respective end cap to define an annular volume therebetween. The annular volume defined between the tubular sleeves accommodates a quantity of material having a high neutron capture cross section. In the example shown, the tubular sleeves are fabricated of stainless steel, and the material having high neutron capture cross section accommodated therebetween is in the form of a stack of annular bodies of pressed and sintered boron carbide. Although not shown, each of the tubular sleeves of the upper local control rod have multiple vent apertures (not shown), similar to vent apertures 128, defined therein.

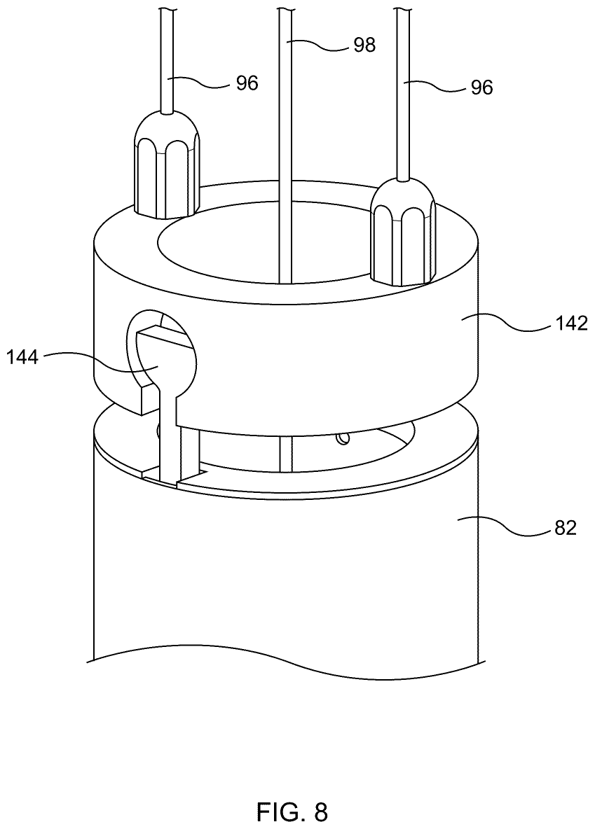

The upper local control rod 82 is connected to the first wire ropes 96 by a gimbal ring 142, which is coupled to an upper end of the upper local control rod 82 by two (2) gimbal ring links 144 as shown in FIG. 8. As will be appreciated, the two (2) gimbal ring links 144 allow the upper local control rod 82 to hang plumb if the first wire ropes 96 are of different length, such as due to manufacturing deviations. In the example shown, each gimbal ring link 144 is fastened to the upper local control rod 82 and comprises a swivel connector received in a respective cavity defined in the gimbal ring 142, however it will be understood that each gimbal ring link 144 may alternatively be fastened to the gimbal ring 142 and comprise a swivel connector received in a respective cavity defined in the upper local control rod 82.

The upper local control rod 82 and the gimbal ring 142 define central cavities that are aligned to accommodate the second wire rope 98.

The guide tube 102 has a generally perforated structure, and is fabricated of a material having a low neutron capture cross section to minimize undesired absorption of free neutrons. In the example shown, the guide tube 102 is fabricated of zirconium or a zirconium alloy, such as for example ASTM B353 UNS R60802 or R60804. As will be understood, undesired absorption of free neutrons by non-fuel materials that form a fixed part of the core 50, sometimes referred to as “parasitic neutron capture”, can be reduced by using materials having a low neutron capture cross section.

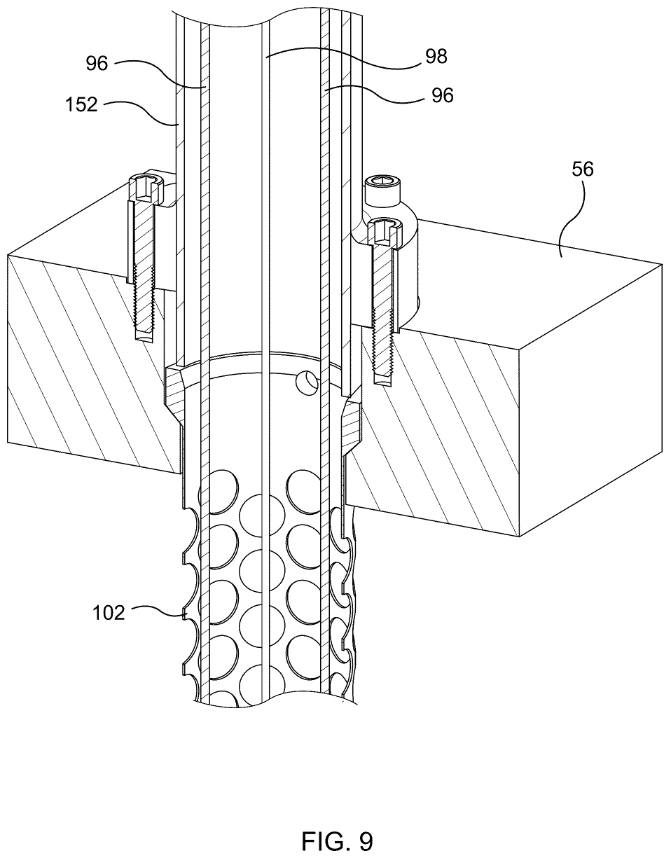

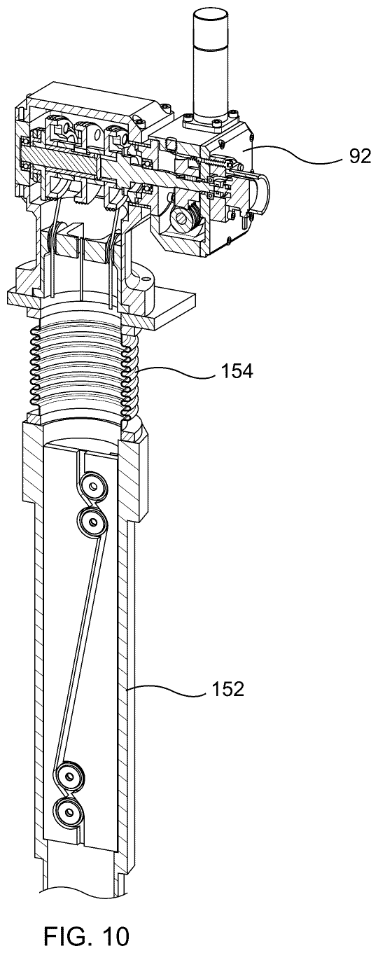

The guide tube 102 is coupled to a tubular conduit or thimble 152 which provides an enclosure accommodating the first wire ropes 96 and second wire rope 98 pending from the local control rod drive mechanism 92, as shown in FIG. 9. The thimble 152 has a lower end that is mounted to an exterior of the reactor vessel 56, and an upper end that is coupled to the local control rod drive mechanism 92 via a flexible bellows 154, as shown in FIG. 10.

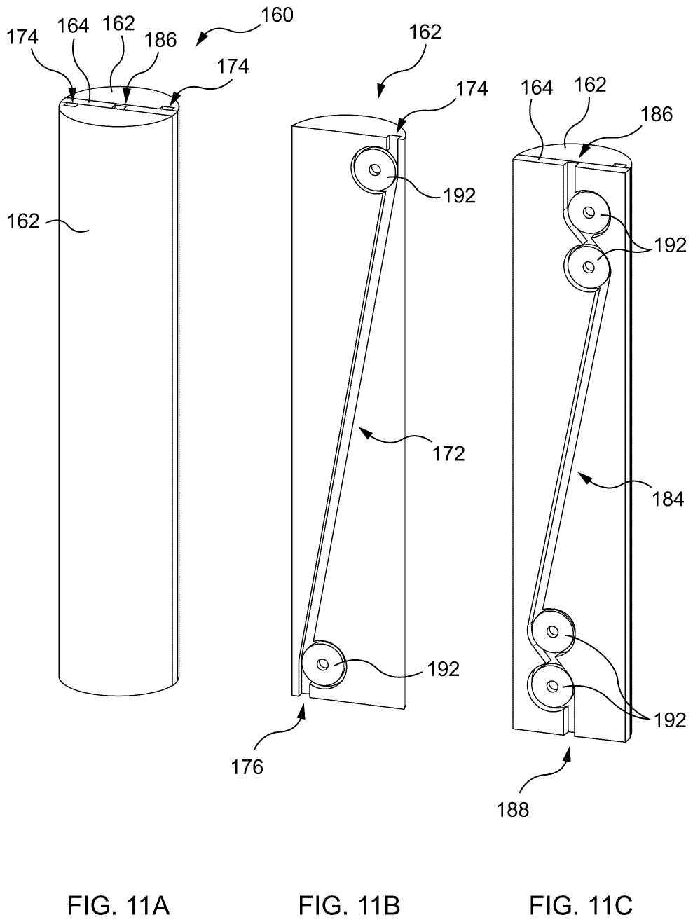

The upper end of the thimble 152 is shaped to accommodate a cylindrical shield plug 160, which defines a plurality of non-vertical, internal pathways accommodating the first wire ropes 96 and the second wire rope 98, for preventing line-of-sight radiation emitted by the reactor 22 from exiting the thimble 152. The shield plug 160 may be better seen in FIGS. 11A to 11C. In the example shown, the shield plug 160 comprises two (2) outer portions 162 of opposite symmetry and a central portion 164 which, when connected by suitable means (not shown) such as fasteners (not shown), yield the assembled shield plug 160. Each outer portion 162, which is configured to accommodate a respective one (1) of the first wire ropes 96, comprises an elongate, generally semi-cylindrical body defining an internal pathway 172, an upper pathway aperture 174 and a lower pathway aperture 176. The central portion 164 comprises an elongate, generally planar body defining an internal pathway 184, an upper pathway aperture 186 and a lower pathway aperture 188. The outer portions 162 and the central portion 164 each house a plurality of pulleys 192, which are configured to facilitate movement of the wire rope through the internal pathway 172 or 184.

The bellows 154 is coupled to the local control rod drive mechanism 92 and the thimble 152 by flanged joints. As will be understood, the bellows 154 is configured to flex axially in response to, and thereby absorb, any vertical movement of the thimble 152 due to thermal expansion and contraction. The bellows 154 has a hollow, corrugated body, which has a small thickness to reduce the amount of conductive heat transfer from the thimble 152 to the local control rod drive mechanism 92.

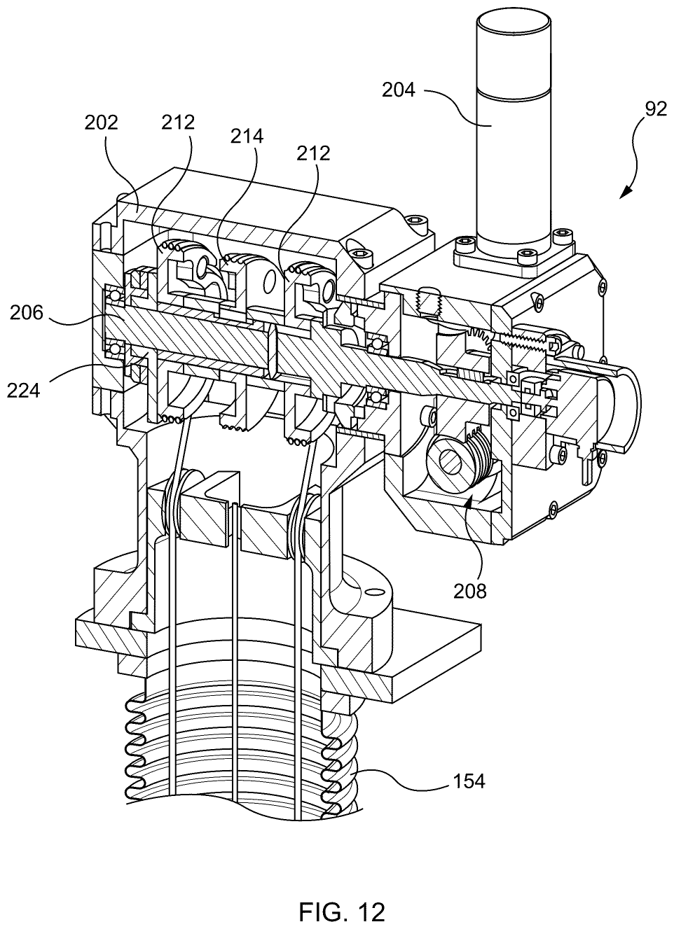

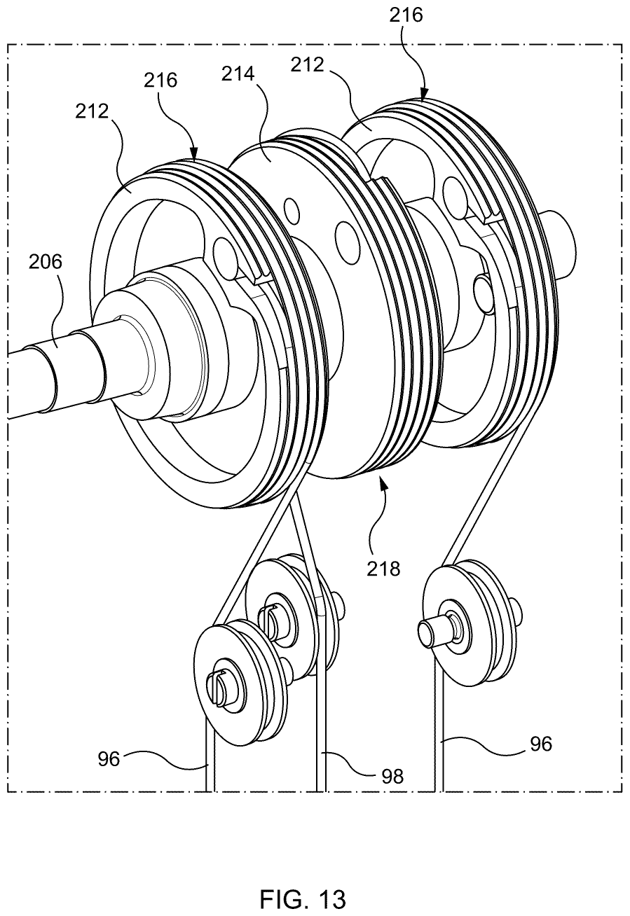

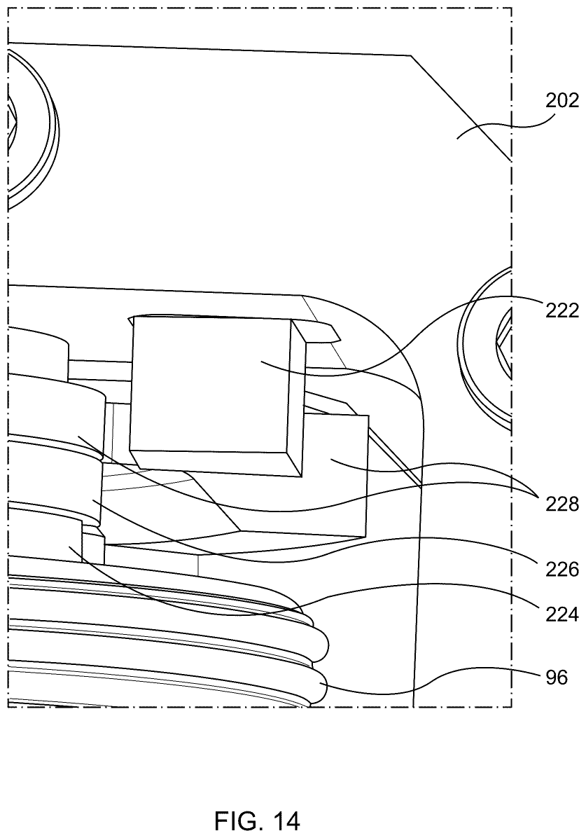

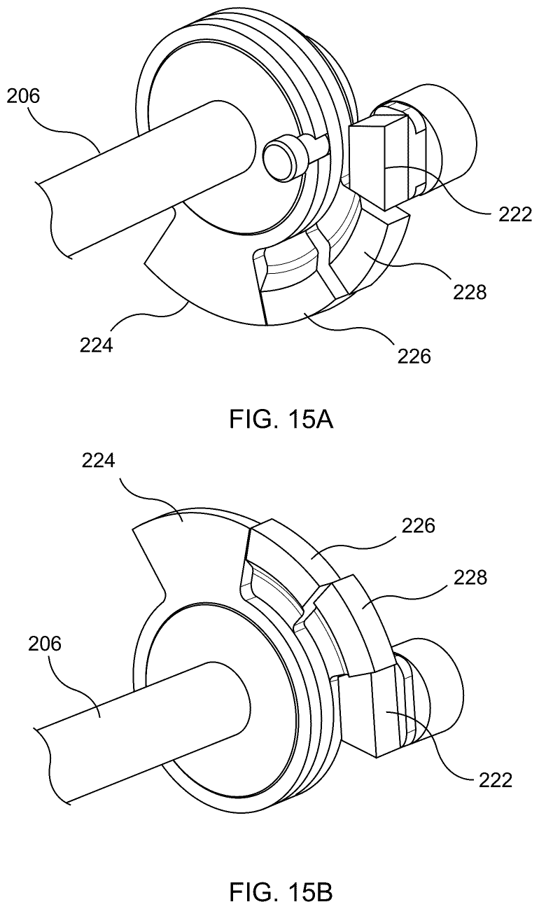

The local control rod drive mechanism 92 may be better seen in FIGS. 12 to 15B. Each local control rod drive mechanism 92 comprises a housing 202 that supports an electric drive motor 204 that is coupled to a rotatable shaft 206 inside the housing 202 by a gearbox 208. The shaft 206 has three (3) drums mounted thereon, namely two (2) first drums 212 and one (1) second drum 214 mounted between the first drums 212. Each of the drums 212 and 214 has a helical, circumferential groove defined therein that is configured to accommodate a length of a respective wire rope. In particular, each first drum 212 has a helical, circumferential groove 216 that is configured to accommodate a length of a respective wire rope 96 wound thereon, and the second drum 214 has a helical, circumferential groove 218 that is configured to accommodate a length of the wire rope 98 wound thereon. The drums 212 and 214 are configured such that the circumferential grooves 216 provide a first helical direction of winding of the first wire ropes 96, while the circumferential groove 218 defined in the second drum 214 provides a second helical direction of winding of the second wire rope 98 opposite to the first helical direction of winding. As will be understood, by configuring the drums 212 and 214 in this manner, rotation of the shaft 206 by the drive motor 204 advantageously causes the upper local control rod 82 to move in a first vertical direction and the lower local control rod 84 to move in a second vertical direction, opposite to the first vertical direction.

Each local control rod drive mechanism 92 further comprises a rotation limit assembly that is configured to define limits of travel of the upper local control rod 82 and the lower local control rod 84. In the example shown, the rotation limit assembly comprises a stop block 222 mounted to the housing 202, a rotation limit end plate 224 fixedly mounted to the rotatable shaft 206, and a rotatable first rotation limit plate 226 and a rotatable second rotation limit plate 228 that are each independently coupled to the rotatable shaft 206 and configured to rotate freely relative thereto. When the upper local control rod 82 and the lower local control rod 84 are being moved between rotation limits, which correspond to the travel limits of the local control rod set 80 shown in FIGS. 6A and 6B, the rotation limit end plate 224 is configured to rotate in unison with the rotatable shaft 206 until abutting one of the rotation limit plates 226 or 228, at which point the rotation limit end plate 224 pushes the rotation limit plate 226 or 228 around the rotatable shaft 206 until it abuts the other of the rotation limit plate 226 or 228, resulting in the rotation limit end plate 224 and the rotation limit plates 226 and 228 becoming stacked. The stacked rotation limit plates 226 and 228 continue to rotate around the rotatable shaft 206 until they abut the stop block 222, which halts rotation of the shaft 206 and thereby establishes one (1) of the two (2) limits of rotation, and hence one (1) of the two (2) limits of travel of the upper local control rod 82 and the lower local control rod 84.

The shutoff units 74 are configured to cause a rapid termination of nuclear fission occurring in the core 50, in response to either a guaranteed shutdown signal received from one or more of the reactor control systems or manual action by an operator. The shutoff units 74 can, for example, be used during an emergency. Each shutoff unit 74 comprises a shutoff rod 230 is coupled to a respective shutoff rod drive mechanism 232 as seen in FIG. 5 that is positioned above the reactor 22. The shutoff rod drive mechanism 232, which is in communication with the processing structure, is generally similar to the local control rod drive mechanism 92 described above, but further includes features to facilitate a rapid, gravity-driven insertion of the shutoff rod 230. Each shutoff rod 230 is coupled to its respective shutoff rod drive mechanism 232 by a single wire rope (not shown). The shutoff rod 230 is configured to move into and out of the core 50 through the interior of a respective guide tube 102, in response to action by the shutoff rod drive mechanism 232.

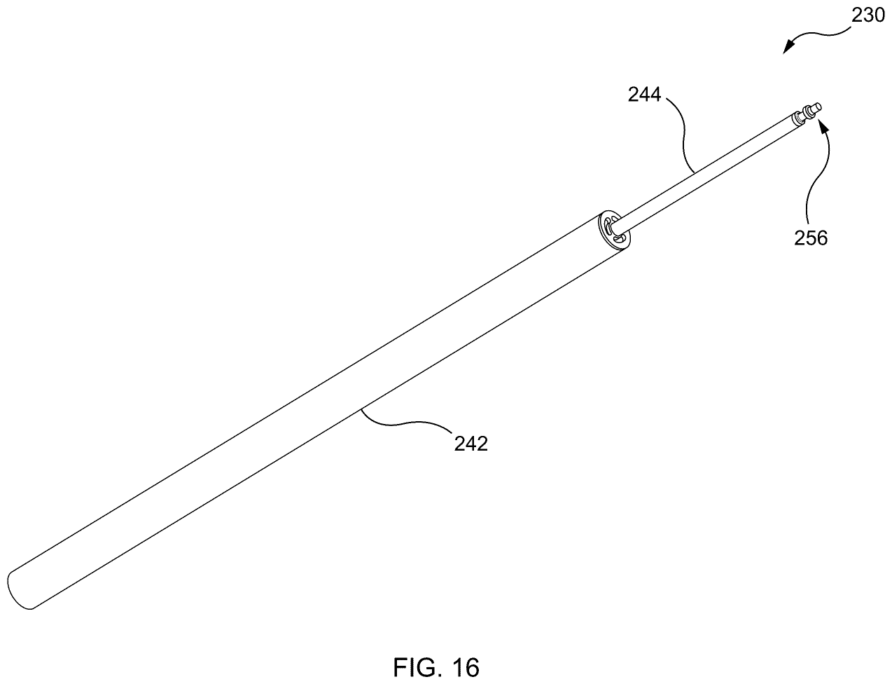

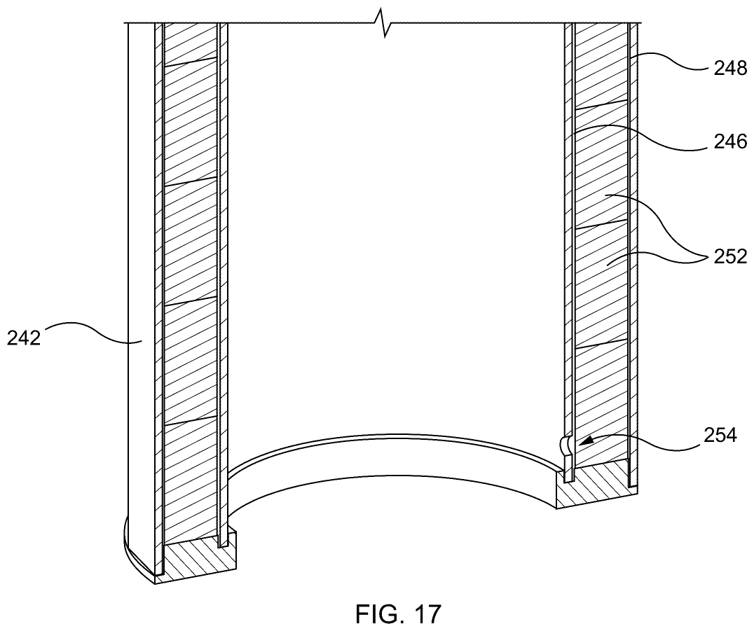

The shutoff rod 230 may be better seen in FIGS. 16 and 17. Each shutoff rod 230 has an absorber member 242, and a support member 244 fastened to an upper end of the absorber member 242. The absorber member 242 has a similar construction as that of the upper local control rod 82 and of each of the first and second lower local control rod segments 106 and 108, and comprises a pair of tubular sleeves 246 and 248 of different diameter that are sealed at each end by a respective end cap to define an annular volume therebetween. It will therefore be appreciated that the absorber member 242 is conceptually identical to the upper local control rod 82 and each of the first and second lower local control rod segments 106 and 108. The annular volume accommodates a quantity of material having a high neutron capture cross section. In the example shown, the tubular sleeves 246 and 248 are fabricated of stainless steel, and the material having high neutron capture cross section accommodated therebetween is in the form of a stack of annular bodies 252 of pressed and sintered boron carbide. One or more other suitable materials having high neutron capture cross section could alternatively or additionally be used, depending on neutron absorption requirements and rod life expectancy requirements. Each of the tubular sleeves 246 and 248 has multiple vent apertures 254 defined therein for i) prior to operation of the reactor 22, allowing atmospheric air present to be purged when the reactor vessel 56 is filled with helium; and ii) during operation of the reactor 22, allowing gas pressure allowing gas pressure generated in the annular volume defined between the tubular sleeves 246 and 248 to escape, similar to apertures 128 described above.

The support member 244 is fastened to the absorber member 242 along its axial centerline by a suitable method, such as for example welding. The support member 244 has a threaded end 256 for providing a connection to a threaded connector (not shown) of the wire rope connecting the shutoff rod 230 to its respective shutoff rod drive mechanism.

The guide tube 102 of the shutoff rod 230 is coupled to a thimble 152, which provides an enclosure accommodating the wire rope pending from the shutoff rod drive mechanism. The thimble 152 is mounted to an exterior of the reactor vessel 56, and has an upper end that is coupled to the shutoff rod drive mechanism via a flexible bellows 154.

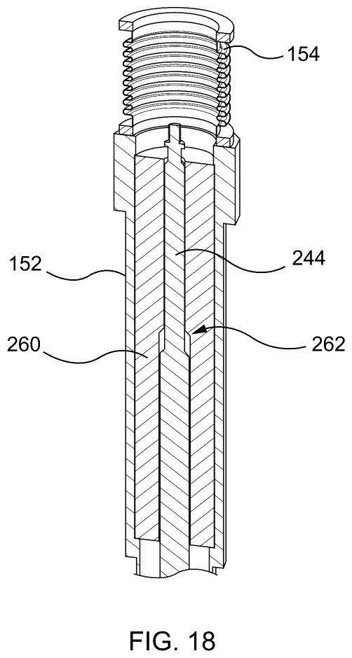

The upper end of the thimble 152 accommodating the shutoff rod 230 is shaped to accommodate a cylindrical shield plug 260, which may be seen in FIG. 18. The shield plug 260 defines a single internal counterbore 262 sized to accommodate a portion of the absorber member 242 and a portion of the support member 244. Owing to relatively close diameter matching of the counterbore 262, the absorber member 242 and the support member 244, and owing to a step in the diameters of the absorber member 242 and the support member 244, the shield plug 260 advantageously prevents line-of-sight radiation emitted by the reactor 22 up through the conduit from exiting the thimble 152.

The bellows 154 is coupled to the shutoff rod drive mechanism and the thimble 152 by flanged joints.

Each shutoff rod drive mechanism 232 coupled to the shutoff rod 230 is generally similar to the local control rod drive mechanism 92 described above, and comprises a housing supporting an electric drive motor that is coupled to a rotatable shaft inside the housing by a gearbox. The drum has a helical, circumferential groove defined therein that is configured to accommodate a length of the wire rope. Rotation of the shaft by the drive motor causes the shutoff rod 230 to be lowered into, or raised from, the core 50.

The guaranteed shutdown units 76 are configured to prevent nuclear fission occurring in the core 50, in response to either a guaranteed shutdown signal received from the reactor control systems or manual action by an operator, to ensure that an unintended restart of the reactor 22 is not possible. The guaranteed shutdown units 76 can, for example, be used during assembly of the core 50, during a period of maintenance of the reactor 22, and/or during any other time when extended guaranteed shutdown of the reactor 22 is required.

Each guaranteed shutdown unit 76 comprises a guaranteed shutdown rod (not shown) that is identical to the shutoff rod 230 described above. Each guaranteed shutdown rod is coupled to a respective guaranteed shutdown unit drive mechanism 272 that is positioned above the reactor 22. The guaranteed shutdown unit drive mechanism 272 is generally similar to the local control rod drive mechanism 92 described above, and is in communication with the reactor control systems. Each guaranteed shutdown rod is coupled to its respective guaranteed shutdown unit drive mechanism 272 by a single wire rope (not shown). The guaranteed shutdown rod is configured to move into and out of the core 50 through the interior of a respective guide tube 102, in response to action by the guaranteed shutdown unit drive mechanism 272.

As with the shutoff unit 74 described above, the guide tube 102 of the guaranteed shutdown unit 76 is coupled to a thimble 152, which provides an enclosure accommodating the wire rope pending from the control rod drive mechanism. The thimble 152 has a lower end that is mounted to an exterior of the reactor vessel 56, and an upper end that is coupled to the guaranteed shutdown unit drive mechanism 272 via a flexible bellows 154.

The upper end of the thimble 152 is shaped to accommodate the cylindrical shield plug 260. The bellows 154 is coupled to the guaranteed shutdown unit drive mechanism 272 and the thimble 152 by flanged joints.

Each guaranteed shutdown unit drive mechanism 272 is generally similar to the local control rod drive mechanism 92 described above, and comprises a housing supporting an electric drive motor that is coupled to a rotatable shaft inside the housing by a gearbox. The drum has a helical, circumferential groove defined therein that is configured to accommodate a length of the wire rope. Rotation of the shaft by the drive motor causes the guaranteed shutdown rod to be lowered into, or raised from, the core 50.

In use, the system 20 is operated by sustaining continuous nuclear fission in the core 50 of the reactor 22. Heat energy generated by fission occurring in the fuel rods 58 spreads through the core 50. To control the amount of heat energy, the local control rod sets 80 are inserted into, or withdrawn from, the core 50 in response to signals received by the respective local control rod drive mechanism 92 from the reactor control systems. When inserted in the core 50, the local control rod sets 80 controllably absorb free neutrons in an amount proportional to their depth of insertion into the core 50, and thereby control the rate of nuclear fission, and hence the rate of heat energy production, in the core 50.

The heat energy is absorbed by the heat pipes 64 and vaporizes the working fluid therein. Vaporized working fluid flows upward through the heat pipe 64, where heat energy from the vaporized working fluid is conducted into the vaporizer 66. Inside the heat pipes 64, the loss of heat energy from the working fluid causes condensation of the working fluid, and the liquid working fluid flows downward by gravity. The heat energy absorbed by the vaporizer 66 heats the heat exchange fluid flowing therethrough. The heated heat exchange fluid then exits the vaporizer 66 and flows through the secondary cooling circuit 24 to the turbine 26, where it rotates the turbine 26 which in turn rotates the alternator 34 to generate electricity. Downstream from the turbine 26, the heat exchange fluid passes through the regenerator 32 and the condenser 28, where it is cooled and returned to the vaporizers 66 of the heat pipes 64 to collect more heat energy originating in the core 50, and thereby sustain the generation of electrical power.

Nuclear fission occurring in the core 50 can be stopped by lowering the shutoff rods 230 and/or the guaranteed shutdown rods into the core 50, in response to either a guaranteed shutdown signal received from the processing structure or manual action by an operator.

As will be appreciated, the “split” configuration of the rods in each local control unit 72, namely the separation into two (2) independently moveable portions 82 and 84, allows the rate of nuclear fission at the center plane of the core 50 to be controlled with greater sensitivity, as the upper local control rod 82 and the lower local control rod 84 generally abut at this center plane. As will be understood, the neutron flux profile of the core 50 is non-uniform, and neutron flux is greatest at the center plane and decreases with vertical distance from the center plane. Thus, the “split” configuration advantageously results in a more symmetric fuel consumption profile than would otherwise be possible with a single rod configuration. As will be understood, this allows the reactor to be more easily controlled, particularly toward in the later portion of life of the fuel of the fuel rods 58, and can potentially extend the fuel life.

Additionally, and as will be appreciated, the “split” configuration of the local control rod set 80 of each local control unit 72 allows the masses of the upper local control rod 82 and the lower local control rod 84 to generally counterbalance each other, which advantageously enables the gearbox 208 and the electric drive motor 204 of the local control rod drive mechanism 92 to experience lighter loads, which in turn reduces stresses and enables the use of smaller components for the gearbox 208 and the electric drive motor 204 to i) operate with less mechanical resistance to provide greater sensitivity of movement for upper and lower control rods 82 and 84, and ii) experience a longer service life than motors of conventional control rod drive mechanisms coupled to single local control rods. For safety reasons, the mass of the upper local control rod 82 is greater than that of the lower local control rod 84 so that if a break in the local control rod drive mechanism occurs, the rod pair will slowly insert into the reactor rather than withdraw.

Although embodiments have been described above with reference to the accompanying drawings, those of skill in the art will appreciate that variations and modifications may be made without departing from the scope thereof as defined by the appended claims.

### LIST OF REFERENCE CHARACTERS

20 nuclear power generating system
22 small modular reactor
24 secondary cooling circuit
26 turbine
28 condenser
32 regenerator
34 alternator
36 pump
42 shield
44 grade
50 reactor core
52 neutron reflector layer
54 thermal insulation layer
56 reactor vessel
58 fuel rods
60 control rod (generic)
62 reactor control unit (generic)
64 heat pipe
66 vaporizer
68 control rod drive mechanism (generic)
70 reactor control unit subsystem
72 local control unit
74 shutoff unit
76 guaranteed shutdown unit
80 local control rod set
82 upper local control rod
84 lower local control rod
92 local control rod drive mechanism
96 first wire rope
98 second wire rope
102 guide tube
106 first lower local control rod segment
108 second lower local control rod segment
110 bore
112 tubular sleeve
114 tubular sleeve
116 annular body
122 tubular sleeve
124 tubular sleeve
126 annular body
128 vent aperture
132 first circumferential cuff
134 second circumferential cuff
136 securing plate
142 gimbal ring
144 gimbal ring link
152 thimble
154 bellows
160 shield plug
162 shield plug outer portion
164 shield plug central portion
172 internal pathway
174 upper pathway aperture
176 lower pathway aperture
184 internal pathway
186 upper pathway aperture
188 lower pathway aperture
192 pulley
202 housing
204 electric drive motor
206 rotatable shaft
208 gearbox
212 first drum
214 second drum
216 circumferential groove
222 stop block
224 rotation limit end plate
226 first rotation limit plate
228 second rotation limit plate
230 shutoff rod
232 shutoff rod drive mechanism
242 absorber member
244 support member
246 tubular sleeve
248 tubular sleeve
252 annular body
254 vent aperture
256 threaded end
260 shield plug
262 counterbore
272 guaranteed shutdown unit drive mechanism

What is claimed is:

1. A local control unit for a small modular reactor, the local control unit comprising:
a local control rod set comprising a pair of movable local control rods; and
a local control unit drive mechanism coupled to the pair of local control rods, the local control unit drive mechanism being configured to move each of the local control rods in opposite directions simultaneously.

2. The local control unit of claim 1, wherein the local control unit drive mechanism is coupled to the pair of local control rods by a plurality of wire ropes.

3. The local control unit of claim 2, wherein the local control unit drive mechanism comprises:
an electric drive motor;
a rotatable shaft coupled to the electric drive motor and supporting a plurality of drums around which the wire ropes are wound, the shaft being configured to be rotated upon activation of the electric drive motor.

4. The local control unit of claim 3, wherein the pair of movable local control rods comprises an upper local control rod and a lower local control rod, and wherein the plurality of drums comprises:
a first drum having a first helical, circumferential groove defined therein and configured to accommodate a length of a first wire rope coupled to the lower local control rod, and
a second drum having a second helical, circumferential groove defined therein and configured to accommodate a length of a second wire rope coupled to the upper local control rod,
wherein the second helical, circumferential groove is helically opposite to the first helical, circumferential groove relative to an axis of rotation of the shaft.

5. The local control unit of claim 4, wherein the plurality of drums further comprises:
a third drum having a third helical, circumferential groove defined therein and configured to accommodate a length of a third wire rope coupled to the upper local control rod,
wherein the third helical, circumferential groove is helically opposite to the first helical, circumferential groove relative to the axis of rotation of the shaft.

6. The local control unit of claim 4, wherein the lower local control rod comprises a first lower local control rod segment and a second lower local control rod segment, the first and second lower local control rod segments having a nested configuration.

7. The local control unit of claim 6, wherein the first lower local control rod segment and the second lower local control rod segment are configured to move telescopically relative to each other.

8. A reactor control unit subsystem for a small modular reactor comprising a reactor core, the reactor control unit subsystem comprising:
a plurality of shutoff units;
a plurality of guaranteed shutdown units; and
a plurality of local control units, each local control unit comprising:
a local control rod set comprising a pair of movable local control rods; and
a local control unit drive mechanism coupled to the pair of local control rods, the local control unit drive mechanism being configured to move each of the local control rods in opposite directions simultaneously into or out of the core.

9. The reactor control unit subsystem of claim 8, wherein:
each shutoff unit comprises:
a shutoff rod, and
a shutoff rod drive mechanism coupled to the shutoff rod and configured to move the shutoff rod into the core; and
each guaranteed shutdown unit comprises:
a guaranteed shutdown rod, and
a guaranteed shutdown unit drive mechanism coupled to the guaranteed shutdown rod and configured to move the guaranteed shutdown rod into the core.

10. The reactor control unit subsystem of claim 9, wherein each of the local control rods, the shutoff rod, and the guaranteed shutdown rod comprises:
a pair of concentrically arranged tubular sleeves of different diameter defining an annular volume therebetween, the tubular sleeves being fabricated of a first material;
a pair of caps disposed at ends of the tubular sleeves sealing the annular volume; and
a plurality of annular bodies of a second material, the second material having a higher neutron capture cross section than the first material.

11. The reactor control unit subsystem of claim 10, wherein the second material is boron carbide.

12. The reactor control unit subsystem of claim 10, wherein the first material is stainless steel.
